(19) United States
(12) Patent Application Publication
(10) Pub. No.: US 2026/0050122 A1
(43) Pub. Date: Feb. 19, 2026

(54) HYBRID OPTICAL FIBER CABLE WITH HOLLOW CORE FIBER SECTIONS AND END SECTIONS

(71) Applicant: University of Central Florida Research Foundation, Inc., Orlando, FL (US)

(72) Inventors: Rodrigo Amezcua-Correa, Orlando, FL (US); Jose Enrique Antonio-Lopez, Orlando, FL (US)

(21) Appl. No.: 19/235,389

(22) Filed: Jun. 11, 2025

Related U.S. Application Data
(60) Provisional application No. 63/659,182, filed on Jun. 12, 2024.

(51) Int. Cl. G02B 6/26; G02B 6/02; G02B 6/38; G02B 6/44

(52) U.S. Cl. CPC G02B 6/262; G02B 6/02328; G02B 6/02395; G02B 6/3801; G02B 6/4457; G02B 6/4486

(57) ABSTRACT

The present disclosure provides a hybrid optical fiber comprising a hollow core fiber section having a first end and a second end, one or more end fiber sections coupled to at least one end of the hollow core fiber section, and optionally a buffer tube encapsulating at least the hollow core fiber section. A hybrid optical cable may include a sheathing and two or more such hybrid optical fibers. Methods may include fabricating hybrid optical fibers by coupling glass core fiber sections to hollow core fiber sections, winding on a reel, and testing. Another method may involve installing and coupling hybrid optical fibers based on inspection results. The hollow core fiber sections may comprise various designs including anti-resonant, photonic bandgap, or nested structures.

### CROSS-REFERENCE TO RELATED APPLICATIONS

The present application claims the benefit under 35 U.S.C. § 119(e) of U.S. Provisional Application Ser. No. 63/659,182, filed Jun. 12, 2024, entitled HYBRID OPTICAL FIBER CABLE WITH GLASS CORE FIBER AND HOLLOW CORE FIBER SECTIONS, naming Rodrigo Amezcua-Correa and Jose Enrique Antonio-Lopez, which is incorporated herein by reference in the entirety.

### GOVERNMENT SUPPORT

This invention was made with government support under Grant Numbers W911NF-19-1-0426 and W911NF-24-1-0008 awarded by the Army Research Office (ARO). The government has certain rights in the invention.

### TECHNICAL FIELD

The present disclosure relates to optical fiber cables, and more particularly to hybrid optical fiber cables incorporating both hollow core fiber sections and glass core fiber sections.

### BACKGROUND

Hollow core fibers (HCFs), including various types such as anti-resonant fibers, photonic bandgap fibers, Kagome fibers, nested anti-resonant nodeless hollow core fibers (NANFS), double nested anti-resonant nodeless hollow core fibers (DNANFS), and other low-loss HCFs, have emerged as promising solutions for data transmission in optical networks. However, their more complex fabrication processes and higher costs compared to glass core fibers (GCFs) pose challenges in practical implementations and field installation. For example, one challenge lies in the precise cleaving and alignment required for splicing HCFs, which complicates deployment, requires specialized equipment, and increases installation time relative to deployment of cables with GCFs. Additionally, installation of HCF cables requires special training and specialized installation crews. There is therefore a need to develop systems and methods to cure the above deficiencies.

### SUMMARY

In some embodiments, a hybrid optical fiber is disclosed. The hybrid optical fiber may include a hollow core fiber (HCF) section having a first end and a second end. The hybrid optical fiber may include one or more end fiber (EF) sections, where a particular one of the one or more EF sections is coupled to one of the first end or the second end of the HCF section. The hybrid optical fiber may include a buffer tube encapsulating at least the HCF section.

In some embodiments, the HCF section may include an anti-resonant hollow core fiber section.

In some embodiments, the anti-resonant hollow core fiber section may include a plurality of anti-resonant (AR) elements formed as walled structures with walls extending along a length of the HCF section. At least one of the plurality of AR elements may surround an interior region and further include one or more support structures in the interior region and formed as at least a portion of at least one of the walls. The one or more support structures may have a non-uniform thickness profile.

In some embodiments, the anti-resonant hollow core fiber section may include a plurality of AR elements formed as walled structures with walls extending along a length of the HCF section. At least some of the plurality of AR elements may be nested to form one or more nested sets of AR elements. An interior region of at least one of the plurality of AR elements may be segmented into two or more interior cavities by one or more segmentation walls extending along the length of the HCF section.

In some embodiments, the HCF section may include at least one of a photonic bandgap fiber or a Kagome fiber.

In some embodiments, the HCF section may include at least one of a nested anti-resonant nodeless hollow core fiber (NANF) or a double nested anti-resonant nodeless hollow core fiber (DNANF).

In some embodiments, the particular one of the one or more EF sections may include at least one of an optical fiber with a glass core or a glass rod.

In some embodiments, the particular one of the one or more EF sections may include a capillary.

In some embodiments, the capillary may be sealed.

In some embodiments, the capillary may be open.

In some embodiments, the particular one of the one or more EF sections may be coupled to one of the first end or the second end of the HCF section via a splice.

In some embodiments, the particular one of the one or more EF sections may be coupled to one of the first end or the second end of the HCF section via an in-line coupler.

In some embodiments, the hybrid optical fiber may include one or more antireflective elements on an end face of at least one of the one or more EF sections coupled to the HCF section.

In some embodiments, the one or more antireflective elements may include one or more antireflective coatings.

In some embodiments, the one or more antireflective elements may include one or more antireflective surface structures.

In some embodiments, the hybrid optical fiber may be wound on a reel.

In some embodiments, a hybrid optical cable is disclosed. The hybrid optical cable may include a sheathing. The hybrid optical cable may include two or more hybrid optical fibers at least partially encapsulated by the sheathing. A particular one of the two or more hybrid optical fibers may include a HCF section having a first end and a second end. The particular one of the two or more hybrid optical fibers may include one or more EF sections, where a particular one of the one or more EF sections is coupled to one of the first end or the second end of the HCF section. At least the HCF section of at least one of the two or more hybrid optical fibers may be at least partially encapsulated with a buffer tube.

In some embodiments, the HCF section of at least one of the two or more hybrid optical fibers may include an anti-resonant hollow core fiber section.

In some embodiments, the HCF section of at least one of the two or more hybrid optical fibers may include at least one of a photonic bandgap fiber, a Kagome fiber, a NANF, or a DNANF.

In some embodiments, the particular one of the one or more EF sections of at least one of the two or more hybrid optical fibers may include at least one of an optical fiber with a glass core, a glass rod, or a capillary.

In some embodiments, the hybrid optical cable may be wound on a reel.

In some embodiments, a method is disclosed. The method may include fabricating one or more hybrid optical fibers. A particular hybrid optical fiber of the one or more hybrid optical fibers may be fabricated by fabricating a HCF section having a first end and a second end. The particular hybrid optical fiber may be fabricated by coupling one or more glass core fiber sections to at least one of the first end and the second end of the HCF section. The method may include winding the one or more hybrid optical fibers on a reel. The method may include testing the particular hybrid optical fiber by coupling a testing device to at least one of the one or more glass core fiber sections of the particular hybrid optical fiber. The method may include performing one or more diagnostic measurements of the particular hybrid optical fiber using the testing device.

In some embodiments, the method may include encapsulating at least one of the one or more hybrid optical fibers in one or more buffer tubes.

In some embodiments, the method may include encapsulating at least one of the one or more hybrid optical fibers in a sheathing to form a hybrid optical cable.

In some embodiments, the HCF section of at least one of the one or more hybrid optical fibers may include an anti-resonant hollow core fiber section.

In some embodiments, the HCF section of at least one of the one or more hybrid optical fibers may include at least one of a photonic bandgap fiber, a Kagome fiber, a NANF, or a DNANF.

In some embodiments, a method is disclosed. The method may include fabricating two or more hybrid optical fibers. A particular hybrid optical fiber of the two or more hybrid optical fibers may be fabricated by fabricating a HCF section having a first end and a second end. The particular hybrid optical fiber may be fabricated by coupling one or more glass core fiber sections to at least one of the first end and the second end of the HCF section. The method may include coupling the two or more hybrid optical fibers via the one or more glass core fiber sections.

In some embodiments, the method may include encapsulating at least one of the two or more hybrid optical fibers in one or more buffer tubes.

In some embodiments, the method may include encapsulating at least one of the two or more hybrid optical fibers in a sheathing to form a hybrid optical cable.

In some embodiments, the HCF section of at least one of the two or more hybrid optical fibers may include an anti-resonant HCF.

In some embodiments, the HCF section of at least one of the two or more hybrid optical fibers may include at least one of a photonic bandgap fiber, a Kagome fiber, a NANF, or a DNANF.

In some embodiments, a method is disclosed. The method may include installing a first hybrid optical fiber and a second hybrid optical fiber. Each of the first hybrid optical fiber and the second hybrid optical fiber may include a HCF section having a first end and a second end. Each of the first hybrid optical fiber and the second hybrid optical fiber may include a first glass core fiber section coupled to the first end. Each of the first hybrid optical fiber and the second hybrid optical fiber may include a second glass core fiber section coupled to the second end. The method may include performing an inspection of the second glass core fiber section of the first hybrid optical fiber and the first glass core fiber section of the second hybrid optical fiber. The method may include coupling the first hybrid optical fiber to the second hybrid optical fiber. When the inspection reveals that the second glass core fiber section of the first hybrid optical fiber and the first glass core fiber section of the second hybrid optical fiber are clear of defects, the method may include coupling the second glass core fiber section of the first hybrid optical fiber to the first glass core fiber section of the second hybrid optical fiber. When the inspection reveals that the second glass core fiber section of the first hybrid optical fiber includes defects and the first glass core fiber section of the second hybrid optical fiber is clear of defects, the method may include coupling the HCF section of the first hybrid optical fiber to the first glass core fiber section of the second hybrid optical fiber. When the inspection reveals that the second glass core fiber section of the first hybrid optical fiber is clear of defects and the first glass core fiber section of the second hybrid optical fiber includes defects, the method may include coupling the second glass core fiber section of the first hybrid optical fiber to the HCF section of the second hybrid optical fiber.

In some embodiments, the first hybrid optical fiber and the second hybrid optical fiber may be encapsulated in respective buffer tubes.

In some embodiments, the first hybrid optical fiber may be a part of a first hybrid optical cable. The second hybrid optical fiber may be a part of a second hybrid optical cable.

In some embodiments, the HCF section of at least one of the first hybrid optical fiber or the second hybrid optical fiber may include an anti-resonant HCF.

In some embodiments, the HCF section of at least one of the first hybrid optical fiber or the second hybrid optical fiber may include at least one of a photonic bandgap fiber, a Kagome fiber, a NANF, or a DNANF.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF FIGURES

The numerous advantages of the disclosure may be better understood by those skilled in the art by reference to the accompanying figures.

FIG. 1A illustrates a simplified schematic of a hybrid optical fiber, in accordance with one or more embodiments of the present disclosure.

FIG. 1B illustrates a sectional view of a hybrid optical fiber, in accordance with one or more embodiments of the present disclosure.

FIG. 2 illustrates a hybrid optical fiber wound on a reel, in accordance with one or more embodiments of the present disclosure.

FIG. 3 illustrates a side view of a hybrid optical fiber encapsulated within a buffer tube, in accordance with one or more embodiments of the present disclosure.

FIG. 4 illustrates a side view of a hybrid optical fiber with a buffer tube wound on a reel, in accordance with one or more embodiments of the present disclosure.

FIG. 5 illustrates a side view of a hybrid optical cable, in accordance with one or more embodiments of the present disclosure.

FIG. 6 illustrates a side view of a hybrid optical cable wound on a reel, in accordance with one or more embodiments of the present disclosure.

FIG. 7A illustrates hybrid optical cables prior to coupling, in accordance with one or more embodiments of the present disclosure.

FIG. 7B illustrates the hybrid optical cables of FIG. 7A after coupling, in accordance with one or more embodiments of the present disclosure.

FIG. 8A illustrates hybrid optical cables with exposed hollow core fiber (HCF) sections prior to coupling, in accordance with one or more embodiments of the present disclosure.

FIG. 8B illustrates hybrid optical cables of FIG. 8A after coupling, in accordance with one or more embodiments of the present disclosure.

FIG. 9 illustrates a flowchart of a method for fabricating and coupling hybrid optical fibers, in accordance with one or more embodiments of the present disclosure.

FIG. 10 illustrates a flowchart of a method for fabricating and testing hybrid optical fibers, in accordance with one or more embodiments of the present disclosure.

FIG. 11 illustrates a flowchart of a method for installing and coupling hybrid optical fibers, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing hybrid optical fibers and cables incorporating hollow core fiber (HCF) sections coupled to end fiber (EF) sections.

The hybrid optical fibers and cables disclosed herein may address several challenges associated with the production, installation, and splicing/connecting of HCF cables. These challenges include, but are not limited to, the precise alignment requirements during splicing, environmental sensitivity of the hollow cores, and specialized equipment needs that can significantly increase deployment time and costs. Further, the relatively complex fabrication processes and higher costs compared to glass core fibers (GCFs) pose challenges in practical implementations and field installation, particularly when considering the specialized training required for installation crews, the additional time needed for proper handling, and the increased risk of performance degradation if not installed correctly. By incorporating EF sections at strategic points, the systems and methods disclosed herein aim to leverage the advantages of both fiber types while mitigating their respective limitations in real-world deployment scenarios.

In embodiments, a hybrid optical fiber may include an HCF section having a first end and a second end, with at least one EF section coupled to one of the first end or the second end of the HCF section. The EF sections may include GCFs, glass rods, capillaries (which may be sealed or open), or other suitable optical waveguide structures that can be effectively coupled to the HCF section. In some embodiments, an EF section of the hybrid optical fiber may be formed from an HCF with suboptimal optical transmission properties (e.g., higher loss compared to a primary HCF section). For example, during HCF fabrication, certain lengths of fiber may have less desirable optical transmission properties than other portions of the fiber. These inferior fiber sections may be utilized as EF sections to protect the primary HCF sections that possess the required optical transmission properties. This configuration may minimize waste of the valuable HCF material with desired transmission characteristics while simultaneously protecting it from the external environment. Alternatively, such an EF section may be collapsed, filled with glue, or packed with epoxy or any other sealant material to provide a sealed end for the primary HCF section.

Various aspects of a hybrid optical fiber may be designed to enhance performance, improve reliability, or facilitate testing. For example, the outer diameters (e.g., coating diameters) of the EF section and an HCF section within a hybrid optical fiber may be designed to be similar or identical along its length, which may simplify production processes. Similarly, maintaining comparable cladding diameters between the EF section and HCF section may facilitate easier splicing. EF sections may optionally be composed of two or more end fibers to ensure efficient coupling of optical signals. The splice/interconnection between the EF section and HCF section may be designed to achieve low insertion loss, ensuring efficient transmission of optical signals, and may also be configured to achieve low return loss. EF sections with low bending loss characteristics can facilitate the splicing of two cables. Additionally, EF section ends may be made compatible with conventional single-mode fibers, which may simplify testing procedures.

The hybrid optical fiber may further include a buffer tube encapsulating at least the HCF section. This configuration may address challenges associated with precise cleaving and alignment required for splicing HCFs, which can complicate deployment and increase installation time.

By incorporating EF sections (e.g., GCF sections, or any other type of sections) at one or both ends of the HCF sections within an optical cable, the systems and methods disclosed herein may simplify splicing, installation, and testing of HCF cables. For example, splicing a hybrid HCF cable to another cable may be performed at the EF sections using traditional splicing techniques, thereby reducing the complexity associated with HCF splicing and speeding up cable deployment.

The invention also addresses issues associated with manufacturing scrap intrinsic in the production of cables with at least one HCF. During cable manufacturing, some fiber may be wasted or scrapped at various stages, leading to increased costs. This is particularly significant since HCFs are typically more expensive than the components used to form the EF sections. By splicing EF sections to both ends of an HCF section to form a hybrid optical fiber, the utilization of the more costly HCF material may be optimized and scrap minimized.

Moreover, if the EF sections are coupled with low loss and/or low reflection to the HCF sections, testing, installation, and splicing of the cable may be simplified compared to cables with HCFs that are not end-coupled to EFs. The incorporation of EF sections at the ends of HCF sections may offer additional benefits, such as protecting the void regions of HCFs from environmental factors like humidity and impurities during transport, manufacturing, and cable installation.

The hybrid optical fibers described herein may be bundled together within a protective sheathing to form a hybrid optical cable. Such a cable may contain two or more hybrid optical fibers that are at least partially enclosed by the outer sheathing. This structural arrangement may provide enhanced mechanical protection and environmental isolation for the enclosed hybrid optical fibers during installation, operation, and maintenance.

The systems and methods disclosed herein may also include various methods for fabricating, testing, and installing hybrid optical fibers and cables. These methods may involve fabricating HCF sections, coupling EF sections to the HCF sections, winding the hybrid optical fibers on reels, and performing diagnostic measurements using testing devices coupled to the EF sections.

By streamlining the cable manufacturing, installation, and splicing processes, the disclosed systems and methods may offer advantages in terms of efficiency and cost-effectiveness compared to traditional approaches. These improvements may be particularly beneficial in optical communication networks where rapid deployment and reliable performance are critical for maximizing productivity and data transmission capabilities.

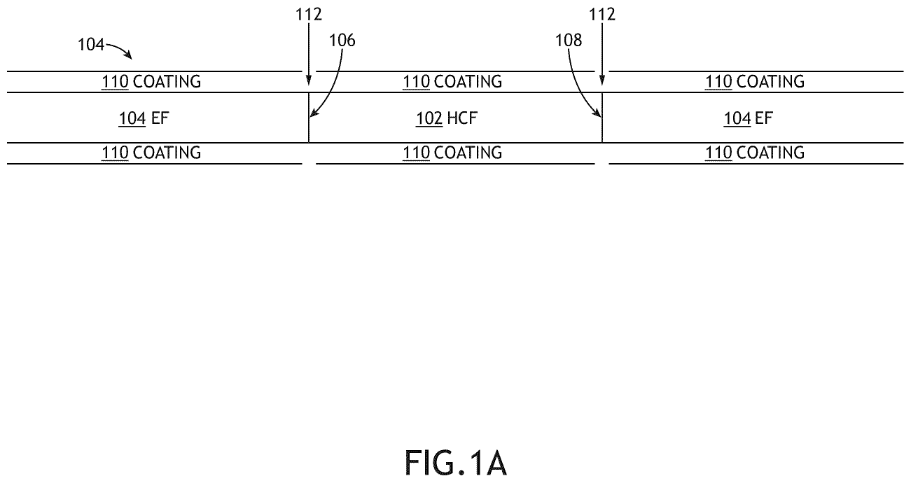

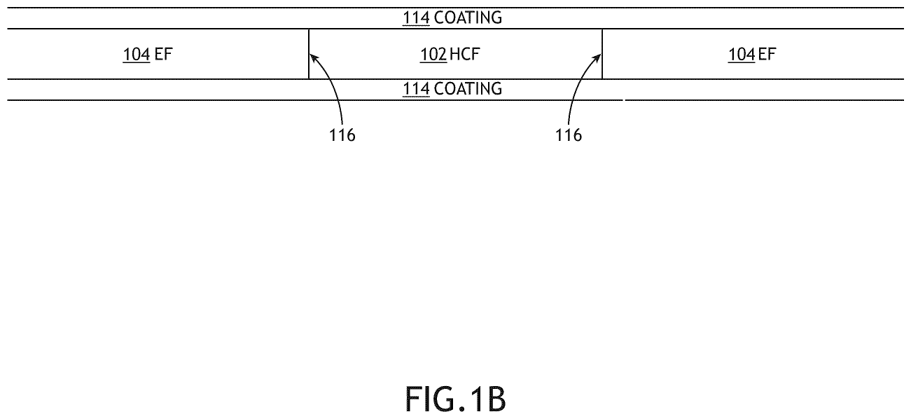

Referring now to FIGS. 1A-11, systems and methods providing hybrid optical fibers are described in greater detail, in accordance with one or more embodiments of the present disclosure.

FIG. 1A illustrates a simplified side view a hybrid optical fiber 100, in accordance with one or more embodiments of the present disclosure. In embodiments, the hybrid optical fiber 100 includes a hollow core fiber (HCF) section 102 having a first end 106 and a second end 108. The hybrid optical fiber 100 further includes at least one end fiber (EF) section 104, where a particular one of the EF sections 104 is coupled to one of the first end 106 or the second end 108 of the HCF section 102.

The HCF sections 102 may include any type of hollow core fiber design. For example, the HCF sections 102 may include any of the HCF designs depicted in U.S. Patent Publication No. 2024/0411083 published on Dec. 12, 2024, U.S. Patent Publication No. 2025/0110269 published on Apr. 3, 2025, U.S. Patent Publication No. 20250004192 published on Jan. 2, 2025, and U.S. Patent Publication No. 2024/0402419 published on Dec. 5, 2024; all of which are incorporated herein by reference in their entireties. As an illustration, an HCF section may be an anti-resonant HCF section with anti-resonant (AR) elements formed as walled structures with walls extending along the fiber length, where at least one of the AR elements surrounds an interior region and further includes one or more support structures in the interior region and formed as at least a portion of at least one of the walls, and where the one or more support structures have a non-uniform thickness profile. As another example, at least some of the anti-resonant elements may be nested to form one or more nested sets of anti-resonant elements. For instance, an interior region of at least one of the anti-resonant elements may be segmented into two or more interior cavities by one or more segmentation walls extending along the length of the hollow core fiber section, where at least one additional anti-resonant element may be located in the interior cavities.

As another example, an HCF section may include a photonic bandgap fiber, a Kagome fiber, a nested anti-resonant nodeless hollow core fibers (NANF), a double nested anti-resonant nodeless hollow core fibers (DNANF), or any other type of HCF design.

The EF sections 104 may include any structure suitable for coupling to the HCF section 102. Further, the EF sections 104 may or may not be suitable for guiding light. For example, the EF sections 104 may include, but are not limited to, GCFs, glass rods, capillaries (which may be sealed or open), or other suitable structures. In some cases, an EF section 104 may be formed from an HCF with suboptimal optical transmission properties, such as higher loss compared to the primary HCF section 102. Additionally, an EF section 104 may be a collapsed HCF, an HCF filled with glue or epoxy, or an HCF packed with any other sealant material to provide a sealed end for the primary HCF section 102. The EF sections 104 may also be composed of two or more end fibers to ensure efficient coupling of optical signals. The EF sections 104 may include different fibers to achieve low loss splice/coupling to the HCF section 102.

In some embodiments, the EF sections 104 may be designed with low bending loss characteristics or made compatible with conventional single-mode fibers to facilitate splicing and testing procedures. Additionally, a hybrid optical fiber 100 including two EF sections 104 may include the same or different types of EF sections 104 on the two ends. Further, markings or other identification techniques (e.g., different colors or band marks) may be applied to identify the EF sections 104 and HCF section 102.

The HCF section 102 may have any length ranging from relatively short segments to extended spans suitable for long-distance transmission applications. For example, the HCF section 102 may be fabricated with lengths shorter than 1 meter for short interconnects, more than a meter for data center connections, 100 meters for building-to-building networks, more than 1 kilometer for extended networks, or surpassing 5 kilometers for long-haul communication links. This flexibility in length allows the HCF section 102 to be tailored to various deployment scenarios. The EF sections 104 may similarly have any suitable length, including, but not limited to, lengths greater than 1 meter, greater than 100 meters, or greater than 1 kilometer. In this way, the length of the EF sections may be tailored to facilitate manufacturing, installation, and/or testing of the hybrid optical fiber 100. More generally, the lengths of the HCF section 102 and the EF sections 104, may be tailored to balance the desired transmission properties of the HCF section 102 with the practical advantages of the EF sections 104 on one or both ends.

An EF section 104 may be coupled with the HCF section 102 using any technique including, but not limited to, a splice or a coupler (e.g., an in-line coupler). Further, a connection between an EF section 104 and HCF section 102 may have a low loss (<1.0 dB) or less than 0.5 dB or less than 0.05 dB.

In some embodiments, the hybrid optical fiber 100 includes one or more antireflective elements between the HCF section 102 and any of the EF sections 104. For example, end facets of the HCF section 102 and EF sections 104 may be angle-cleaved with complementary profiles to achieve low back reflections. As another example, an EF section 104 may include antireflective elements on an end face to be coupled with the HCF section 102. The hybrid optical fiber 100 may incorporate any type of antireflective elements. For example, the end facet of an EF section 104 may be treated with one or more antireflective coatings fabricated using any technique known in the art such as, but not limited to, sputtering, ion beam deposition, plasma deposition, or ion-assisted deposition. As another example, surface structures designed to provide anti-reflective properties may be fabricated on the end facet of an EF section 104. As an illustration, the end facet of an EF section 104 may be fabricated to include biomimetic structures such as, but not limited to, moth-eye structures. As another illustration, the end facet of an EF section 104 may be fabricated to include random antireflection structures. Further, surface structures designed to provide anti-reflective properties may be fabricated using any technique known in the art such as, but not limited to, nanoimprinting or laser processing.

In some embodiments, one or more components of the hybrid optical fiber 100 include a coating. For example, FIG. 1A depicts a configuration in which the HCF section 102 and the EF sections 104 each have a separate coating 110. For example, FIG. 1A may correspond to a configuration in which the HCF section 102 and the EF sections 104 are fabricated with the separate coatings 110 and then jointed together via splicing, a coupler, or any other suitable technique. In this configuration, gaps 112 may be present between the separate coatings 110.

FIG. 1B illustrates a simplified side view of a hybrid optical fiber 100 with a continuous coating 114, in accordance with one or more embodiments of the present disclosure. For example, the coating 114 may cover the coupling locations 116 between the HCF section 102 and the EF sections 104. The continuous coating 114 may be fabricated using any suitable technique. In some embodiments, the separate coatings 110 in FIG. 1A may be stripped and a new coating 114 may be applied. In some embodiments, the separate coatings 110 may be supplemented or repaired to form the coating 114.

Referring generally to FIGS. 1A-1B, the HCF section 102 and the EF sections 104 may have any suitable dimensions.

For example, in an application where an EF section 104 may guide light, the mode field diameter of the EF section 104 may be the same or substantially similar to the mode field diameter of the HCF section 102 to achieve low loss during coupling. As another example, outer cladding diameters of the HCF section 102 and the EF sections 104 may be designed to be the same or substantially similar. As another example, outer coating diameters of the HCF section 102 and the EF sections 104 may be designed to be the same or substantially similar.

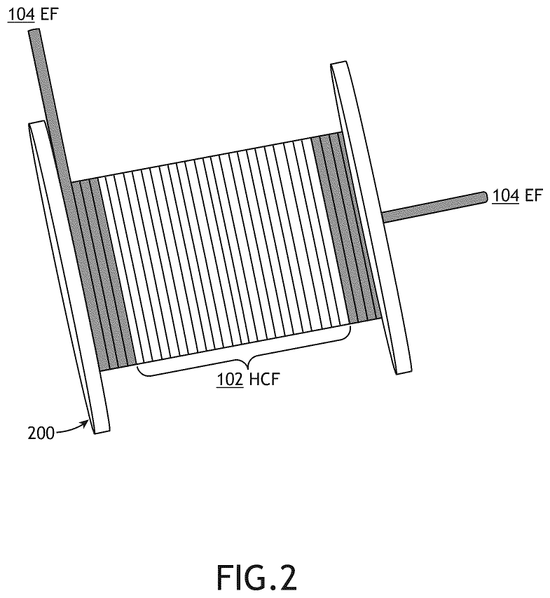

Referring now to FIG. 2, packaging and transport of a hybrid optical fiber 100 are described.

In some embodiments, the hybrid optical fiber 100 is provided on a reel, which may facilitate storage, transportation, installation, and/or testing.

FIG. 2 illustrates a simplified schematic of a fiber system including a hybrid optical fiber wound on a reel 200, in accordance with one or more embodiments of the present disclosure. A reel 200 may include any object around which the hybrid optical fiber 100 and/or a cable including one or more hybrid optical fibers 100 may be wound. In some cases, the reel 200 may be cylindrical in shape with flanges on either end to contain the wound fiber. The reel 200 may be made of any suitable material such as, but not limited to, plastic, wood, metal, or composite materials, depending on the specific requirements for storage and transportation.

A hybrid optical fiber 100 may be mounted to the reel 200 using various techniques. In some cases, one end of the hybrid optical fiber 100 may be secured to the reel 200 using an adhesive or mechanical fastener. The hybrid optical fiber 100 may then be wound around the reel 200 in a controlled manner, maintaining a consistent tension to prevent damage or distortion to the fiber. The winding process may continue until the entire length of the hybrid optical fiber 100 is mounted on the reel 200. In some cases, the other end of the hybrid optical fiber 100 may be secured to prevent unwinding during transport or handling.

The reel 200 may secure the hybrid optical fiber 100 while providing access to one or both of the EF sections 104. As shown in FIG. 2, one EF section 104 may be accessible from the top of the reel 200, while another EF section 104 may be accessible from the side of the reel 200. This arrangement may facilitate testing, installation, or other procedures that require access to the ends of the hybrid optical fiber 100 without necessitating complete unwinding of the fiber from the reel 200. For example, the optical properties of the hybrid optical fiber 100 may be conveniently analyzed/measured by directly connecting one or both ends of the hybrid optical fiber 100 to a test device, even when the hybrid optical fiber 100 is on the reel 200. Any type of test device may be used including, but not limited to, an optical time domain reflectometer (OTDR) or an optical spectrum analyzer. Further, any type of measurement may be performed such as, but not limited to, a loss measurements, a chromatic dispersion measurement, or polarization mode dispersion measurement.

In some embodiments, a hybrid optical fiber 100 includes a buffer tube to encapsulate at least a HCF section 102, where the buffer tube may provide mechanical strength as well as protection of coupling locations and/or the HCF section 102. More generally, a buffer tube may encapsulate portions of a single fiber (e.g., a single hybrid optical fiber 100) or multiple fibers (e.g., at least one hybrid optical fiber 100 and potentially other fiber types).

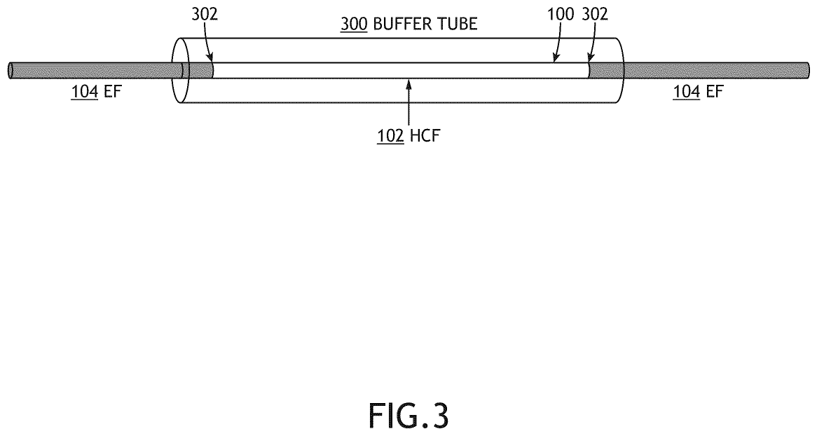

FIG. 3 illustrates a side view of a hybrid optical fiber 100 encapsulated within a buffer tube 300, in accordance with one or more embodiments of the present disclosure. In FIG. 3, the hybrid optical fiber 100 includes a HCF section 102 coupled to two EF sections 104 at coupling locations 302. For example, the buffer tube 300 may extend along a length of the hybrid optical fiber 100 to encapsulate at least a portion of the the the HCF section 102 and/or at least one of the coupling locations 302.

The buffer tube 300 may be designed to encapsulate and protect at least the HCF section 102 of the hybrid optical fiber 100. In some cases, the buffer tube 300 may encapsulate portions of one or more hybrid optical fibers 100. The buffer tube 300 may serve various functions such as grouping and arranging optical fibers within an optical cable, providing mechanical isolation, protection from physical damage, or facilitating fiber identification.

The buffer tube 300 may be fabricated using any suitable material. In some cases, the buffer tube 300 may be made of polypropylene, polybutylene terephthalate (PBT) material, or other materials. The buffer tube 300 may have various dimensions to accommodate different configurations of hybrid optical fibers 100. In some cases, the buffer tube 300 may have a diameter of 1 mm, 2 mm, 3 mm, 5 mm, or greater than 5 mm. The specific diameter may be selected based on factors such as the number of hybrid optical fibers 100 to be encapsulated, desired mechanical properties, or installation requirements.

In some cases, the buffer tube 300 may be filled with additional materials to enhance protection or performance of the hybrid optical fiber 100. For example, the buffer tube 300 may be filled with water absorbing gel, absorbing yarns, and/or powder. These materials may help prevent moisture ingress or provide additional mechanical cushioning for the hybrid optical fiber 100.

Special markings may be applied to the buffer tube 300 to identify the EF sections 104 and HCF section 102. These markings may include, but are not limited to, strips, rings, different colors, or printed information on the buffer tube 300. Such markings may facilitate identification and handling of specific sections of the hybrid optical fiber 100 during installation or maintenance.

A buffer tube 300 may be fabricated using any technique known in the art. For example, to create a buffer tube 300, one or more optical fibers (e.g., one or more hybrid optical fibers 100) to be encapsulated may be first placed on a payoff. The buffering tube 300 may then be extruded around the one or more optical fibers. During this process, the one or more optical fibers are unwound from the payoff drum and fed through an extrusion system, which creates the buffer tube 300 around the optical fibers.

The buffer tube manufacturing process may result in some length of fiber that is scrapped on one or both ends of the buffer tube 300. For example, it may take some time for a buffering machine to produce a steady-state buffer tube 300 with a desired geometry (e.g., diameter) and/or tube characteristics. Fabricating a hybrid optical fiber 100 with EF sections 104 may facilitate cost-efficient manufacturing by ensuring that the scrap may include portions of the EF sections 104 rather than more expensive HCF sections 102. In particular, a buffer manufacturing process may be initiated with an EF section 104 of a hybrid optical fiber 100 such that any scrap (or at least some of the scrap) associated with dialing in the buffer manufacturing process may be portions of the EF section 104 rather than the HCF section 102.

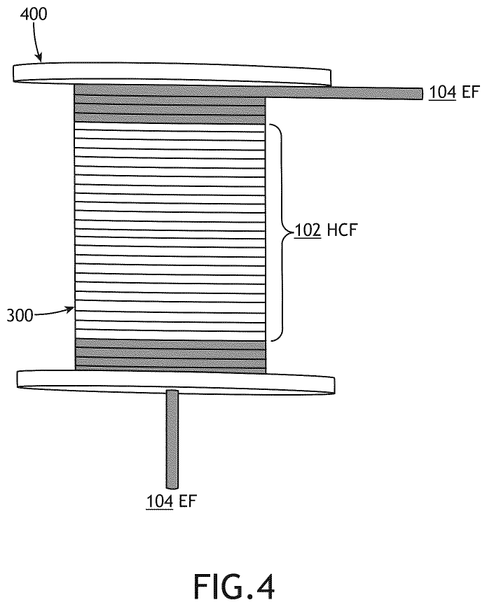

FIG. 4 illustrates a side view of a hybrid optical fiber including a buffer tube and wound on a reel, in accordance with one or more embodiments of the present disclosure. FIG. 4 is substantially similar to FIG. 2, except that the hybrid optical fiber 100 on the reel 400 has a buffer tube 300. Accordingly, the description of FIG. 2 may be extended to FIG. 4.

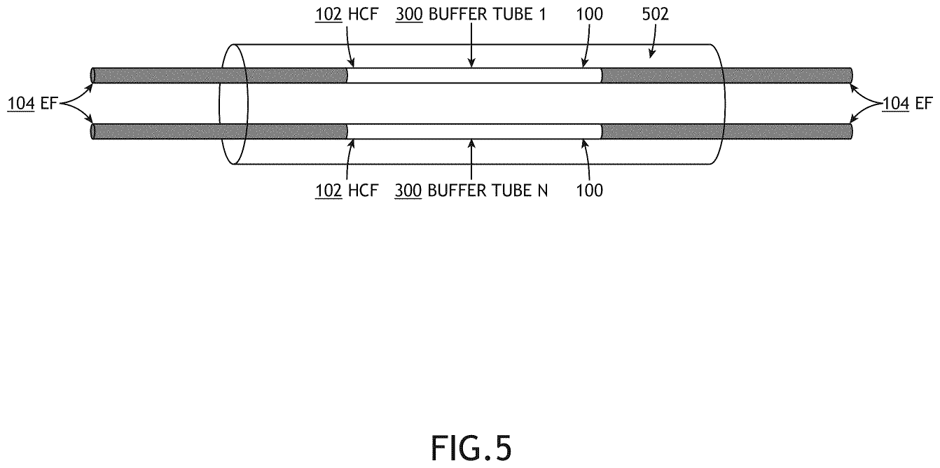

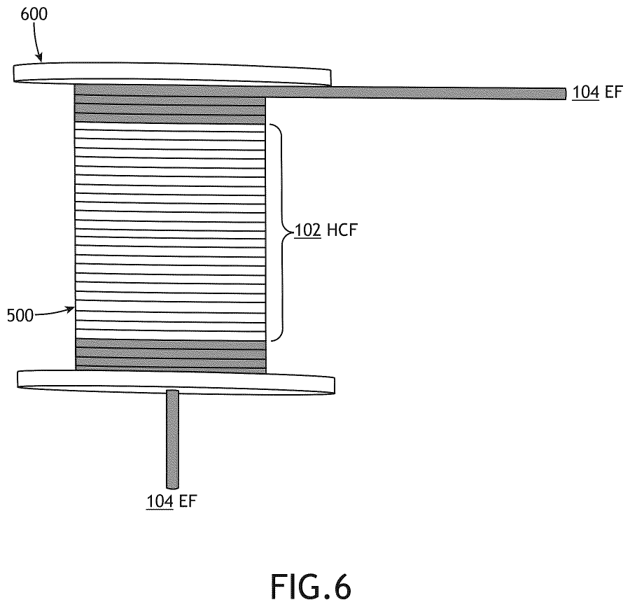

Referring now to FIGS. 5-6, hybrid optical cables including at least one hybrid optical fiber 100 are described.

FIG. 5 illustrates a side view of a hybrid optical cable 500, in accordance with one or more embodiments of the present disclosure. In embodiments, a hybrid optical cable 500 may include two or more fibers at least partially encapsulated by a sheathing 502, where at least one is a hybrid optical fiber 100. two or more hybrid optical fibers 100. For example, the hybrid optical cable 500 may incorporate one or more hybrid optical fibers 100 and may potentially include other types of optical fibers such as, but not limited to, GCFs.

In some embodiments, the hybrid optical fibers 100 may further include one or more buffer tubes 300, where any of the buffer tubes 300 may encapsulate any number of fibers. The sheathing 502 may also encase the buffer tubes 300 if present.

The sheathing 502 may be fabricated from any suitable material that provides mechanical protection and environmental isolation for the enclosed hybrid optical fibers 100. In some cases, markings may be applied to the sheathing 502 to identify the lengths containing EF sections 104 and HCF sections 102. These markings may include, but are not limited to, strips, rings, or printed information on the sheathing 502. Such markings may facilitate identification and handling of specific sections of the hybrid optical cable 500 during installation or maintenance.

FIG. 6 illustrates a side view of a reel 600 with a hybrid optical cable 500, in accordance with one or more embodiments of the present disclosure. FIG. 6 is substantially similar to FIG. 2 and FIG. 4, except that the fiber system includes a hybrid optical cable 500 wound around the reel 600. Accordingly, the description of FIG. 2 and/or FIG. 4 may be extended to FIG. 6.

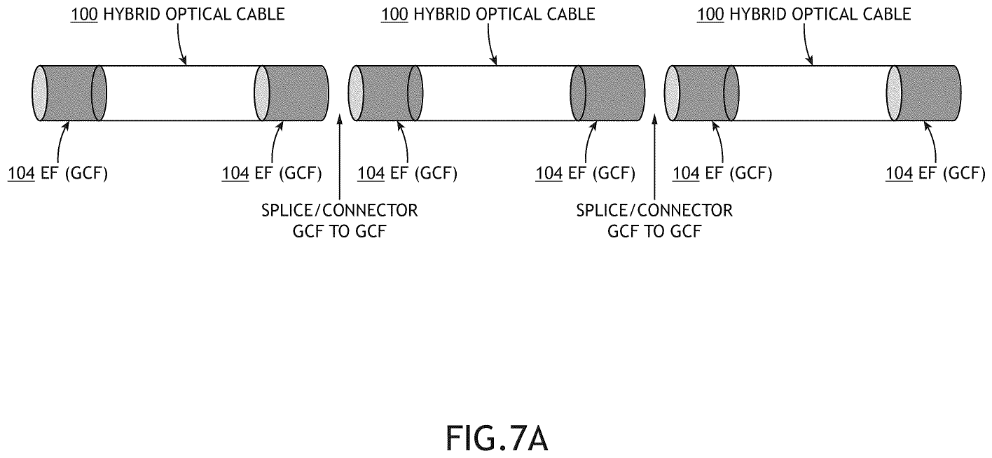

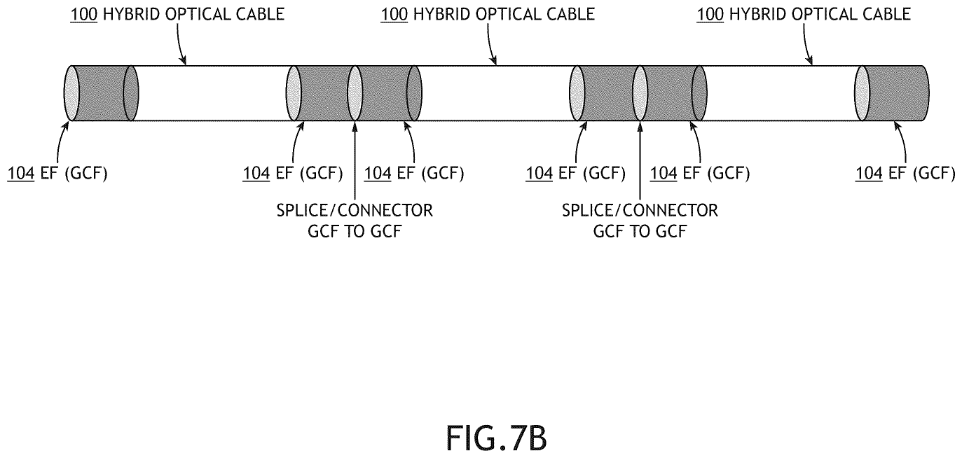

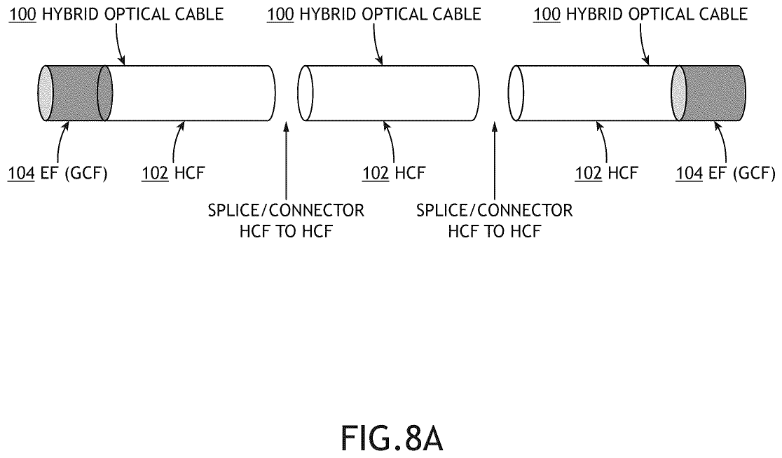

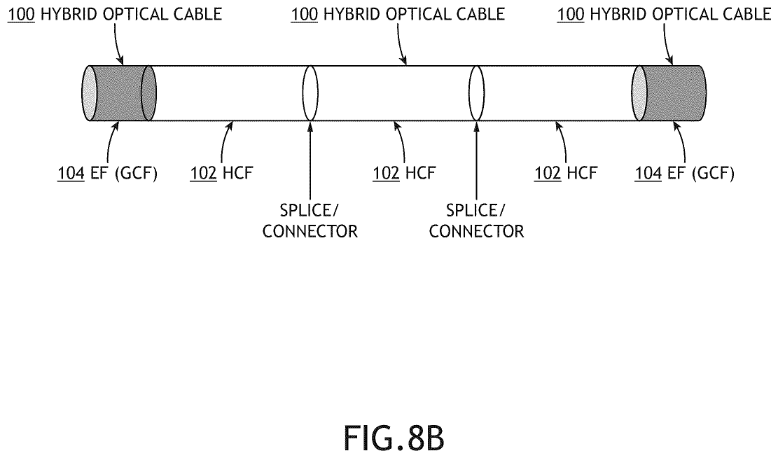

Referring now to FIGS. 7A-8B, techniques for splicing hybrid optical fibers 100 and/or hybrid optical cables 500 are described.

It is contemplated herein that it may be necessary or desirable to splice multiple optical fibers (or cables including optical fibers) together. For example, it may be desirable to splice multiple optical fibers to span a long distance between two connection points. As another example, it may be desirable to splice in sections of optical fiber to repair damaged sections. The splices may be performed in a variety of locations such as, but not limited to, hand holes, pits, man holes, trailers, buildings, telephone poles, splice closures, electrical enclosures, fiber-optic rack, fiber-optic box, or the like. To protect the splicing points between two cables, fiber splices are protected inside a fiber splice closure.

It is further contemplated herein that it may be easier in some applications to splice GCFs than HCFs. Further, GCFs may provide relatively robust handling and bending loss, which may make the splicing process faster, easier, and lower cost compared to HCFs. As an illustration, certain HCFs exhibit sensitivity to bending loss, necessitating splicing in large splicing closures or trays.

In some embodiments, a hybrid optical fiber 100 may include EF sections 104 formed as GCFs, where the transmission properties of the GCFs as well as the coupling loss is sufficient to meet performance specifications for a given application. In this configuration, the EF sections 104 may be used as splice points.

FIGS. 7A-7B illustrate splicing multiple hybrid optical fibers 100 at EF sections 104 formed as GFS. FIG. 7A illustrates a simplified schematic depicting three hybrid optical fibers 100 prior to coupling, in accordance with one or more embodiments of the present disclosure. FIG. 7B illustrates a simplified schematic of the hybrid optical fibers 100 in FIG. 7A after coupling, in accordance with one or more embodiments of the present disclosure.

In some applications, it may be desirable to couple HCF sections 102 of hybrid optical fibers 100 directly. For example, this approach may be used if the EF sections 104 do not meet desired specifications, such as loss or reflection characteristics, or if the EF sections 104 are damaged.

FIG. 8A illustrates a configuration of hybrid optical fibers 100 prior to coupling, in accordance with one or more embodiments of the present disclosure. In particular, EF sections 104 are removed from both ends of a center hybrid optical fiber 100 and from one end of two outer hybrid optical fibers 100. In this way, the HCF sections 102 of the three hybrid optical fibers 100 are ready for coupling. FIG. 8B illustrates a simplified schematic of the hybrid optical cables 500 in FIG. 8A after coupling, in accordance with one or more embodiments of the present disclosure. The resulting combined hybrid optical fiber 100 has EF sections 104 on the ends.

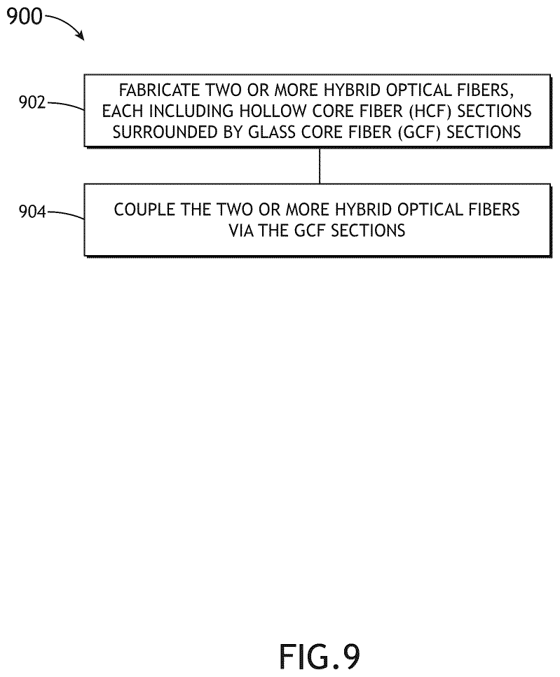

Referring now to FIGS. 9-11, various methods for fabricating, coupling, installing, and testing hybrid optical fibers 100 are described.

FIG. 9 illustrates a flowchart of a method 900 for fabricating and coupling hybrid optical fibers, in accordance with one or more embodiments of the present disclosure. The method 900 may correspond to an implementation of FIGS. 7A-7B.

The method 900 may include a step 902 of fabricating two or more hybrid optical fibers 100. In some cases, each of the two or more hybrid optical fibers 100 may be fabricated by first fabricating HCF sections 102 and then coupling EF sections 104 to ends of the HCF sections 102. The coupling between the HCF section 102 and the GCF EF sections 104 may be achieved using any suitable technique such as fusion splicing, mechanical splicing, or using in-line couplers.

The method 900 may include a step 904 of coupling the hybrid optical fibers 100 via the EF sections 104 (e.g., the GCFs). The coupling between the EF sections 104 of the hybrid optical fibers 100 may also be achieved using any suitable technique such as fusion splicing, mechanical splicing, or using in-line couplers.

In some cases, after coupling the GCF sections to the HCF section 102, the hybrid optical fiber 100 may be recoated to form a continuous coating 114 over the coupling locations 302. This recoating process may help protect the splice points and provide a uniform outer diameter along the length of the hybrid optical fiber 100.

In some cases, the method 900 may include additional steps such as encapsulating at least one of the hybrid optical fibers 100 in one or more buffer tubes 300. The buffer tubes 300 may provide additional protection for the hybrid optical fibers 100 during handling and installation.

In some cases, the method 900 may include encapsulating at least one of the hybrid optical fibers 100 in a sheathing 502 to form a hybrid optical cable 500. The sheathing 502 may provide further protection and structural support for multiple hybrid optical fibers 100 within a single cable structure.

The method 900 may also include winding the hybrid optical fibers 100 or hybrid optical cables 500 onto one or more reels for storage, transportation, or deployment.

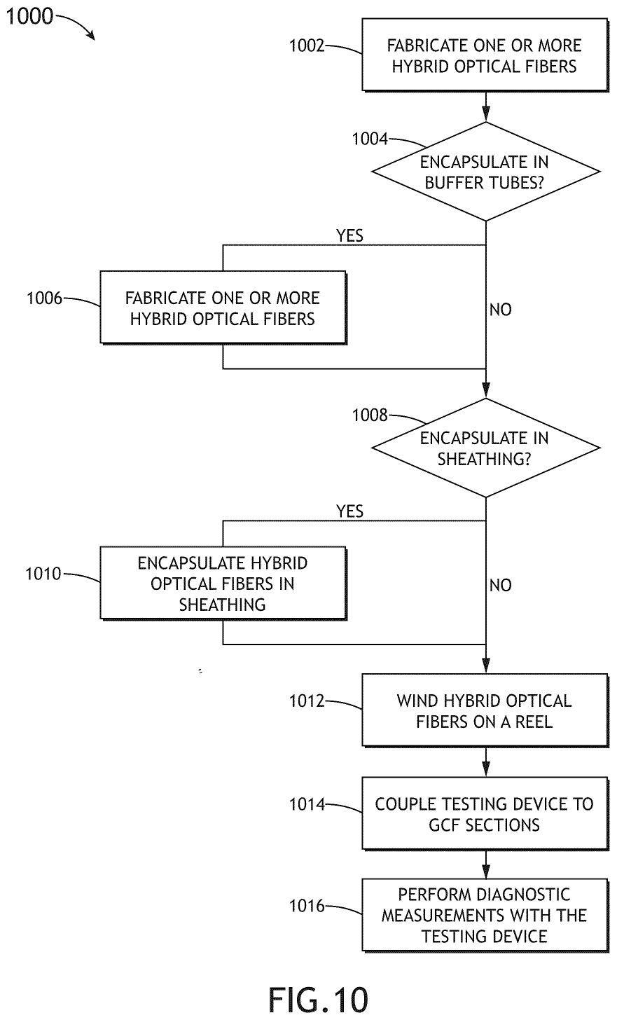

FIG. 10 illustrates a flowchart of a method 1000 for fabricating and testing hybrid optical fibers, in accordance with one or more embodiments of the present disclosure.

The method 1000 may include a step 1002 of fabricating one or more hybrid optical fibers 100. In some cases, fabricating each of the hybrid optical fibers 100 may include fabricating a hollow core fiber (HCF) section 102 and coupling GCF EF sections 104 to one of the first end 106 and the second end 108 of the HCF section 102. The coupling between the HCF section 102 and the GCF EF sections 104 may be achieved using any suitable technique such as fusion splicing, mechanical splicing, or using in-line couplers.

The method 1000 may include a step 1004 of determining whether to encapsulate the hybrid optical fibers 100 in buffer tubes 300. If the decision at step 1004 is affirmative, the method 1000 may include a step 1006 of encapsulating at least one of the hybrid optical fibers 100 in one or more buffer tubes 300. The buffer tubes 300 may provide additional protection for the hybrid optical fibers 100 during handling and installation.

The method 1000 may include a step 1008 of determining whether to encapsulate the hybrid optical fibers 100 in sheathing 502. If the decision at step 1008 is affirmative, the method 1000 may include a step 1010 of encapsulating at least one of the hybrid optical fibers 100 in a sheathing 502 to form a hybrid optical cable 500. The sheathing 502 may provide further protection and structural support for multiple hybrid optical fibers 100 within a single cable structure.

The method 1000 may include a step 1012 of winding the one or more hybrid optical fibers 100 on a reel. In some cases, if a hybrid optical cable 500 has been formed, the hybrid optical cable 500 may be wound on the reel. The reel may facilitate storage, transportation, and deployment of the hybrid optical fibers 100 or hybrid optical cables 500.

The method 1000 may include a step 1014 of coupling a testing device to the GCF EF sections 104 sections of at least one of the hybrid optical fibers 100. The testing device may include any suitable equipment for analyzing optical properties, such as an optical time domain reflectometer (OTDR) or an optical spectrum analyzer.

The method 1000 may include a step 1016 of performing one or more diagnostic measurements of the particular one of the hybrid optical fibers 100 using the testing device. These diagnostic measurements may include, but are not limited to, loss measurements, chromatic dispersion measurements, or polarization mode dispersion measurements. The ability to perform these measurements using the GCF sections may simplify the testing process compared to directly testing HCF sections 102.

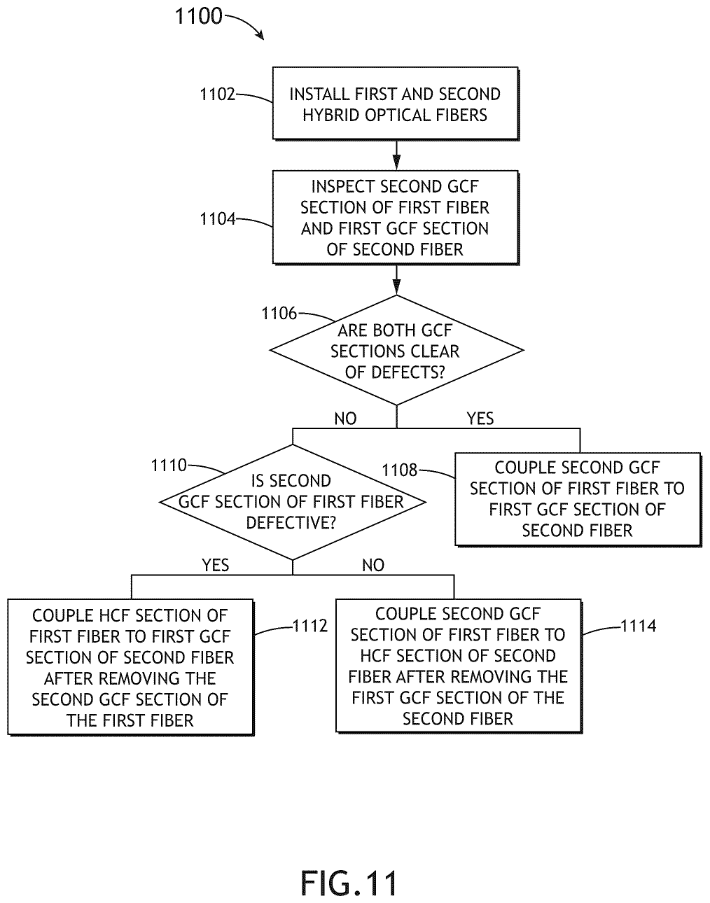

FIG. 11 illustrates a flowchart of a method 1100 for installing and coupling hybrid optical fibers, in accordance with one or more embodiments of the present disclosure.

The method 1100 may include a step 1102 of installing a first hybrid optical fiber 100 and a second hybrid optical fiber 100. In some cases, each of the first and second hybrid optical fibers 100 may include a hollow core fiber (HCF) section 102 having a first end 106 and a second end 108, a first GCF section coupled to the first end 106 of the HCF section 102, and a second GCF section coupled to the second end 108 of the HCF section 102. The GCF sections may serve as the end fiber (EF) sections 104 of the hybrid optical fibers 100.

The method 1100 may include a step 1104 of inspecting the second GCF section of the first hybrid optical fiber 100 and the first GCF section of the second hybrid optical fiber 100. For example, it may be desirable to couple the first hybrid optical fiber 100 and the second hybrid optical fiber 100 somewhere between the respective HCF sections 102. This inspection may involve examining the end faces of the GCF sections for any defects, contamination, or damage that could affect the coupling process.

The method 1100 may include a step 1106 of determining whether both GCF sections are clear of defects. If both sections are clear of defects, the method 1100 may proceed to a step 1108 of coupling the second GCF section of the first hybrid optical fiber 100 to the first GCF section of the second hybrid optical fiber 100. This coupling may be performed using standard GCF splicing techniques, which may be simpler and more reliable than directly splicing HCF sections 102.

If the GCF sections are not both clear of defects, the method 1100 may include a step 1110 of determining if the second GCF section of the first hybrid optical fiber 100 is defective. If this section is defective, the method 1100 may include a step 1112 of coupling the HCF section 102 of the first hybrid optical fiber 100 to the first GCF section of the second hybrid optical fiber 100 after removing the defective second GCF section of the first hybrid optical fiber 100. If the second GCF section of the first hybrid optical fiber 100 is not defective, the method 1100 may include a step 1114 of coupling the second GCF section of the first hybrid optical fiber 100 to the HCF section 102 of the second hybrid optical fiber 100 after removing the defective first GCF section of the second hybrid optical fiber 100.

In some cases, the first and second hybrid optical fibers 100 may be encapsulated in respective buffer tubes 300. The buffer tubes 300 may provide additional protection for the hybrid optical fibers 100 during the installation and coupling process.

In some cases, the first hybrid optical fiber 100 may be a part of a first hybrid optical cable 500, and the second hybrid optical fiber 100 may be a part of a second hybrid optical cable 500. The hybrid optical cables 500 may include a sheathing 502 that encapsulates multiple hybrid optical fibers 100.

Any of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period of time. For example, the memory may be random access memory (RAM), and the results may not necessarily persist indefinitely in the memory.

It is further contemplated that each of the embodiments of the method described above may include any other step(s) of any other method(s) described herein. In addition, each of the embodiments of the method described above may be performed by any of the systems described herein.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

1. A hybrid optical fiber comprising:
a hollow core fiber section having a first end and a second end;
one or more end fiber sections, wherein a particular one of the one or more end fiber sections is coupled to one of the first end or the second end of the hollow core fiber section; and
a buffer tube encapsulating at least the hollow core fiber section.

2. The hybrid optical fiber of claim 1, wherein the hollow core fiber section comprises:
an anti-resonant hollow core fiber section.

3. The hybrid optical fiber of claim 2, wherein the anti-resonant hollow core fiber section comprises:
a plurality of anti-resonant elements formed as walled structures with walls extending along a length of the hollow core fiber section, wherein at least one of the plurality of anti-resonant elements surrounds an interior region and further includes one or more support structures in the interior region and formed as at least a portion of at least one of the walls, wherein the one or more support structures have a non-uniform thickness profile.

4. The hybrid optical fiber of claim 2, wherein the anti-resonant hollow core fiber section comprises:
a plurality of anti-resonant elements formed as walled structures with walls extending along a length of the hollow core fiber section, wherein at least some of the plurality of anti-resonant elements are nested to form one or more nested sets of anti-resonant elements, wherein an interior region of at least one of the plurality of anti-resonant elements is segmented into two or more interior cavities by one or more segmentation walls extending along the length of the hollow core fiber section.

5. The hybrid optical fiber of claim 1, wherein the hollow core fiber section comprises:
at least one of a photonic bandgap fiber or a Kagome fiber.

6. The hybrid optical fiber of claim 1, wherein the hollow core fiber section comprises:
at least one of a nested anti-resonant nodeless hollow core fiber (NANF) or a double nested anti-resonant nodeless hollow core fiber (DNANF).

7. The hybrid optical fiber of claim 1, wherein the particular one of the one or more end fiber sections comprises:
at least one of an optical fiber with a glass core or a glass rod.

8. The hybrid optical fiber of claim 1, wherein the particular one of the one or more end fiber sections comprises:
a capillary.

9. The hybrid optical fiber of claim 8, wherein the capillary is sealed.

10. The hybrid optical fiber of claim 8, wherein the capillary is open.

11. The hybrid optical fiber of claim 1, wherein the particular one of the one or more end fiber sections is coupled to one of the first end or the second end of the hollow core fiber section via a splice.

12. The hybrid optical fiber of claim 1, wherein the particular one of the one or more end fiber sections is coupled to one of the first end or the second end of the hollow core fiber section via an in-line coupler.

13. The hybrid optical fiber of claim 1, further comprising:
one or more antireflective elements on an end face of at least one of the one or more end fiber sections coupled to the hollow core fiber section.

14. The hybrid optical fiber of claim 13, wherein the one or more antireflective elements comprise:
at least one of one or more antireflective coatings or one or more antireflective surface structures.

15. (canceled)

16. The hybrid optical fiber of claim 1, wherein the hybrid optical fiber is wound on a reel.

17. A hybrid optical cable comprising:
a sheathing; and
two or more hybrid optical fibers at least partially encapsulated by the sheathing, wherein a particular one of the two or more hybrid optical fibers comprises:
a hollow core fiber section having a first end and a second end; and
one or more end fiber sections, wherein a particular one of the one or more end fiber sections is coupled to one of the first end or the second end of the hollow core fiber section, wherein at least the hollow core fiber section of at least one of the two or more hybrid optical fibers is at least partially encapsulated with a buffer tube.

18. The hybrid optical cable of claim 17, wherein the hollow core fiber section of at least one of the two or more hybrid optical fibers comprises:
an anti-resonant hollow core fiber section.

19. The hybrid optical cable of claim 17, wherein the hollow core fiber section of at least one of the two or more hybrid optical fibers comprises:
at least one of a photonic bandgap fiber, a Kagome fiber, a nested anti-resonant nodeless hollow core fiber (NANF), or a double nested anti-resonant nodeless hollow core fiber (DNANF).

20. The hybrid optical cable of claim 17, wherein the particular one of the one or more end fiber sections of at least one of the two or more hybrid optical fibers comprises:
at least one of an optical fiber with a glass core, a glass rod, or a capillary.

21. The hybrid optical cable of claim 17, wherein the hybrid optical cable is wound on a reel.

22-36. (canceled)
